(19) United States
(12) Patent Application Publication
(10) Pub. No.: US 2015/0135978 A1
(43) Pub. Date: May 21, 2015

(54) GLASS FIBER-REINFORCED SLEEVE FOR THE PRINTING INDUSTRY

(71) Applicant: Flint Group Germany GmbH, Stuttgart (DE)

(72) Inventor: Alexander Klitza, Bocholt (DE)

(21) Appl. No.: 14/362,966

(22) PCT Filed: Dec. 7, 2012
(86) PCT No.: PCT/EP2012/074832

§ 371 Date: Jun. 5, 2014

(30) Foreign Application Priority Data
Dec. 9, 2011 (EP) 11192780.2

(51) Int. Cl. B29C 35/08; B41N 6/00; C03C 25/10

(52) U.S. Cl. CPC B29C 35/0805; C03C 25/101; B41N 6/00; B29C 2035/0827; B29K 2507/04
USPC 101/368; 428/34.5; 264/494

(57) ABSTRACT

A method for producing electrically conducting, glass fiber-reinforced sleeves for the printing industry by means of UV curing, and also printing sleeves produced by means of this method, where the glass fibers used are coated with electrically conductive nanoparticles.

The present invention relates to a method for producing electrically conducting, glass fiber-reinforced sleeves for the printing industry by means of UV curing, and also to printing sleeves produced by means of this method.

In flexographic printing, the flexograph printing plates used can be applied in principle directly to the printing cylinder, by being adhered to the printing cylinder with double-sided adhesive tape, for example.

In order to allow rapid changeover of printing plates, however, it is usual to use what are called sleeves. A sleeve is a cylindrical hollow body onto which the printing plates are mounted, or which may also be enveloped completely with a printing layer. The sleeve technology permits very rapid and simple changeover of the printing form. The internal diameter of the sleeves corresponds almost to the outer diameter of the printing cylinder, allowing the sleeves to be simply slipped over the printing cylinder of the printing machine. The slipping of the sleeves on and off operates virtually without exception on the air-cushion principle: for the sleeve technology, the printing machine is equipped with a specific printing cylinder, known as an air cylinder. The air cylinder possesses a compressed-air connection on the end face, by which compressed air can be passed into the interior of the cylinder. From there it can emerge again via holes arranged on the outside of the cylinder. For the fitting of a sleeve, compressed air is passed into the air cylinder and emerges again from the exit holes. The sleeve can then be slipped onto the air cylinder, since it expands slightly under the influence of the air cushion, and the air cushion significantly reduces the friction. When the compressed-air supply is switched off, the expansion is removed, and the sleeve sits firmly on the surface of the air cylinder. Further details of the sleeve technology are disclosed in, for example, “Technik des Flexodrucks”, p. 73 ff., Coating Verlag, St. Gallen, 1999.

Modern sleeves customarily have a multilayer construction. In this regard, reference may be made to U.S. Pat. No. 6,703,095 B2, for example. The basis in the case of modern sleeves is formed by a thin sleeve of hollow cylindrical form, also called printing sleeve. Applied to this sleeve there may be one or more further layers of a polymeric material.

The stated sleeve consists customarily of fiber-reinforced polymeric materials. For their manufacture, glass fibers, glass fiber meshes or else carbon fibers may be used, in combination with thermally curable resins or with UV-curable resins such as polyester resins or epoxy resins, for example. The glass fibers or glass fiber meshes may be impregnated with the aforesaid resins, for example, wound around a rotating core, and then cured thermally or by means of UV light. Before being used, the glass fibers are customarily coated with suitable adhesion promoters, in order to maximize adhesion between the glass fiber and the resin into which the glass fibers are embedded.

For the printing industry, UV curing of the uncured sleeves is quicker and more reliable than thermal curing, and is therefore a preferred technology.

The stated polymer resins are not electrically conducting. It is a widespread technical requirement that the printing sleeves are to have a certain electrical conductivity, in order to establish a conductive connection between the sleeve surface and the metallic printing cylinder. The purpose of this is to prevent electrostatic charging of the sleeves in the course of printing.

While the requirement for a certain electrical conductivity is comparatively easy to meet in the case of thermally curing systems, by the admixing, for example, of electrically conductive particles such as carbon black into the resin, this requirement causes great problems when producing printing sleeves with UV-curable resins, since a resin containing carbon black is not UV-transparent and hence the possibility of UV curing no longer exists.

DE 27100 118 C2 discloses the production of a sleeve to be slipped onto printing cylinders, using glass fiber-reinforced resin, as for example glass fiber-reinforced polyester resin or glass fiber-reinforced epoxy resin.

DE 196 34 033 C1 discloses a sleeve for being slipped onto printing cylinders, this sleeve comprising a seamless inner layer of fiber-reinforced plastic. Applied thereto is an outer layer of an electrically conductive elastic material. In order to ensure electrical conductivity for the purpose of preventing electrostatic charging, the inner layer comprises electrically conductive metal braid which at least at one point contacts the printing cylinder—when the sleeve has been slipped onto it—and which at one point at least contacts the electrically conductive outer layer.

EP 943 432 A1 discloses a sleeve to be slipped onto printing cylinders, this sleeve comprising a seamless inner layer of fiber-reinforced plastic. Applied to this layer is an outer layer of an electrically conductive elastic material. In order to ensure electrical conductivity for the purpose of preventing electrostatic charging, the inner layer comprises electrically conductive threads, such as copper threads, for example, thereby producing an electrically conductive connection between the printing cylinder—when the sleeve has been slipped onto it—and the outer layer at one point at least.

WO 99/44957 discloses coated glass fibers and glass-fiber bundles. Coating is performed with an aqueous formulation which comprises a polymeric material and also inorganic particles having a high thermal conductivity.

JP 09-208 268 A discloses the coating of glass fibers with formulations comprising particles of colloidal SiO₂, calcium carbonate, kaolin or talc, the average diameter being 5 to 2000 nm. The particles are bound to the glass fiber in an amount of 0.001 to 2.0 wt %, based on the glass fiber.

It is an object of the invention to provide a method for producing glass fiber-reinforced, electrically conductive printing sleeves by means of UV curing.

Surprisingly it has been found that this objective can be achieved by coating the glass fibers that are used with electrically conductive nanoparticles, and using the glass fibers thus coated for producing sleeves for the printing industry. Found accordingly has been a method for producing glass fiber-reinforced sleeves for the printing industry by means of UV curing, said method having at least the following method steps:
(1) shaping of a UV-curable sleeve from glass fibers and a UV-curable resin,
(2) curing of the sleeve by UV irradiation,
   where the glass fibers used are provided in an upstream method step with an adhesion-promoting coating, and the formulation used for the coating comprises electrically conductive nanoparticles.

In a preferred embodiment of the invention, the electrically conductive nanoparticles are carbon nanotubes.

In a second aspect of the invention, a glass fiber-reinforced sleeve for the printing industry has been found, comprising at least glass fibers and also a cured resin, the glass fibers having an adhesion-promoting coating comprising electrically conductive nanoparticles.

In a third aspect of the invention, the use of the sleeves of the invention for printing has been found.

Details of the invention now follow.

The sleeves of the invention for the printing industry have, in a manner known in principle, the shape of a hollow cylinder. They are intended for application to a metallic printing cylinder.

For the method of the invention, in a first method step, glass fibers are provided with an adhesion-promoting coating, the adhesion-promoting coating comprising electrically conductive nanoparticles.

The glass fibers used may preferably be filaments, although in principle it is also possible for prefabricated glass fiber meshes or glass fiber fabrics to be used.

Suitable glass fibers are known in principle to the skilled person. For example, glass fibers having a linear density of 600 to 800 tex may be used.

Adhesion-promoting coatings for glass fibers are known in principle to the skilled person. In order to improve the adhesion, it is possible in accordance with the invention with preference to use organofunctional silanes, particularly those of the structure R—Si(OR′)₃. In this formula, R is an organic group which is able to interact with organic materials, polymeric materials for example, and the groups OR′ are readily hydrolyzable groups such as methoxy or ethoxy groups. The alkoxy groups are able to undergo hydrolysis in the presence of moisture, and the silanol groups formed react with the glass surface. The group R points away from the glass surface, and endows the coated glass fibers with effective adhesion to organic materials. The silanes in question may be amino-functional silanes, for example, meaning that the group R has amino groups. Adhesion promoters of these kinds are available commercially.

In accordance with the invention, the formulation used for the coating comprises electrically conductive nanoparticles.

The term “nanoparticles” is known in principle to the skilled person. These are very small particles, for which the particle size already has a significant effect on the chemical and physical properties. Generally speaking, in accordance with the invention, nanoparticles having a particle size of less than 100 nm are used, as for example 1 to 100 nm, preferably 1 to 10 nm, and more preferably 1 to 5 nm. Where the particles in question are spherical or approximately spherical, this dimension relates to the diameter. To the skilled person it is clear that these values constitute average values. Where the particles in question are rodlet-shaped, this figure relates to the thickness.

The nanoparticles in question may in principle be any desired nanoparticles, subject to the proviso that they have a certain electrical conductivity. In one preferred embodiment of the invention, the nanoparticles are carbon nanotubes. Carbon nanotubes are known in principle to the skilled person. The diameter of the carbon nanotubes used may be 1 to 50 nm. For the practice of the invention, preference is given to carbon nanotubes having a diameter of 1 to 10 nm, and more preferably 1 to 5 nm. These may be single-wall or multiwall carbon nanotubes, as for example two-wall carbon nanotubes. In the case of tubes, of course, the length is greater than the diameter. Generally speaking, the length/thickness ratio is at least 10:1 as for example 10:1 to 1000:1. The length of carbon nanotubes of the stated thickness may amount, for example, to about 1.5 μm.

In one embodiment of the invention, the electrically conductive nanoparticles are single-wall carbon nanotubes.

In another embodiment of the invention, the electrically conductive nanoparticles are multiwall carbon nanotubes.

The amount of the electrically conductive nanoparticles, more particularly of the carbon nanotubes, is determined by the skilled person in accordance with the desired properties of the sleeve for the printing industry, more particularly with the desired conductivity. They may be used, for example, in an amount of 0.5 to 50 wt %. The weight fraction of the nanoparticles in the coating is preferably 0.5 to 40 wt %, more preferably 20 to 40 wt %, based on the sum of all of the constituents of the coating.

The amount of the coating, based on the glass fiber, is determined by the skilled person in accordance with the desired properties of the glass fibers and/or of the sleeves for the printing industry that are to be produced with them. It has proven appropriate to use the coating in an amount of 0.1 to 5 wt %, preferably 1 to 5 wt %, and more preferably 1.5 to 4 wt %, based on the glass fibers.

For the coating of the glass fibers, the formulations used for the coating, more particularly organofunctional silanes, are mixed with the nanoparticles, and the mixtures are applied to the glass fibers by means of customary technologies. For instance, the nanoparticles may be included in the sizes which are applied to the spun filament in the course of the filament-drawing operation. Besides the organofunctional silanes and the nanoparticles, the size may further comprise customary film formers, plasticizers, wetting agents, and antistats. A description of glass fiber production is given in, for example, M. Flemming, G. Zimmermann, S. Roth, Faserverbundbauweisen, Springer-Verlag Berlin Heidelberg 1995, section 2.3.

UV-curable resins used for producing the sleeve may be UV-curable resins available commercially and known to the skilled person, examples being resins based on polyester acrylates, epoxy acrylates, polyether acrylates, or urethane acrylates. The UV-curable resin may also itself be electrically conductive; preferably it is a customary resin which is not electrically conductive. Polyester acrylates and urethane acrylates may be employed with preference. Resin formulations of these kinds are available commercially and may of course additionally comprise further components.

The shaping of the UV-curable sleeve from the glass fibers and the UV-curable resin may be performed in principle in accordance with techniques known to the skilled person. For example, the sleeves may be produced largely manually. For this purpose a cylindrical rotating core can be used, glass fibers or glass fiber meshes can be wound gradually around the core, and UV-curable resin may be applied in layers until the desired thickness is reached.

In a preferred embodiment of the method, the production may be performed by means of the filament winding process. For this process, glass fibers are held in such a way that they can be unwound, on what are called reel stands. The mold used is a rotating cylindrical core, to which the fibers are applied, with the glass fibers being impregnated with the UV-curable resin prior to their application to the core.

Under positional and tension guidance, the glass fibers are applied to the rotating cylindrical core, until the desired wall thickness is reached.

When the desired wall thickness has been reached, the sleeve is cured, in method step (2), by UV irradiation. This may preferably take place with the sleeve being rotated on the cylindrical core. As a result of this, the UV curing achieved is particularly uniform.

The UV curing is possible with the method of the invention, even if the electrically conductive nanoparticles that are used, such as the carbon nanotubes that are used, for example, are able to absorb UV light. The reason is that the coating of the glass fibers with the nanoparticles allows their amount to be reduced significantly by comparison with the addition of electrically conductive particles to the resin. The nanoparticles are located only on the surface of the glass fibers. Since the glass fibers are in contact with one another in the sleeve, electrically conducting connections are created, even if the resin between the fibers has no conductivity.

The wall thickness of the cured sleeves for the printing industry is guided by the intended use of the sleeves. The thickness may in particular be 0.2 to 10 mm, preferably 0.5 mm to 2 mm.

The length of the sleeves is guided by the intended use of the sleeves. The length may be 200 mm to 4000 mm, preferably 400 mm to 2000 mm, without any intention hereby to confine the invention to this range.

The fraction of the glass fibers in the sleeve will be determined by the skilled person in accordance with the desired properties of the glass fiber-reinforced sleeve. The fraction ought as a general rule not to be below 50 wt %, in order to ensure sufficient mechanical stability and sufficient electrical conductivity. The amount is preferably 55 to 80 wt %, based on the sum of all of the constituents of the glass fiber-reinforced sleeve.

The method of the invention advantageously includes a further method step, wherein the sleeves are additionally provided with a metallic component for the purpose of improving the conduction of electrical charge from the sleeve to a metallic printing cylinder, with the component connecting the interior outer face of the sleeve to the interior of the sleeve wall.

This component is a metal part of a type such that after the sleeve has been slipped onto a metallic printing cylinder, the part contacts the printing cylinder, thereby creating an electrically conducting connection to the printing cylinder. Moreover, the metal part reaches into the interior of the wall of the sleeve. This improves the conduction of electrical charges from the sleeve to the printing cylinder.

The metallic component may for example be a metallic contact pin, which is inserted into the wall of the sleeve, a metallic ring, which is placed laterally onto the sleeve; or a perforated tongue, which is used on the inside at one end of the sleeve. A perforated tongue also serves for positioning the sleeve on a printing cylinder with a register element.

By means of the method of the invention, electrically conductive sleeves for the printing industry are obtained in a method using UV curing. One of the ways by which the conductivity can be adjusted by the skilled person is via the amount of the glass fibers and the amount of the electrically conductive particles used to coat the glass fibers. The conductivity here is to be at least sufficient to prevent electrostatic charging of the sleeve or of the whole sleeve assembly during the printing process. Generally speaking, the electrical resistance of the printing sleeve ought not to exceed 1 MΩ.

The sleeves of the invention for the printing industry can be obtained by means of the described method of the invention. They encompass glass fibers and also a cured resin, with the glass fibers having an adhesion-promoting coating comprising electrically conductive nanoparticles. The construction and the preferred parameters of the printing sleeves have already been described.

Applied on the outer surface of the glass fiber-reinforced sleeve there may be further layers with different compositions. For example, one or more layers of elastomeric or thermoset polymeric materials may be applied. Suitable layer sequences are known to the skilled person. By this means, for example, the printing length may be adjusted.

The sleeves of the invention can be used in a manner known in principle for printing, such as for flexographic printing, for example. The sleeves in question here may be the glass fiber-reinforced sleeves described, as such, or may be sleeves to which further layers have additionally been applied. For this purpose, the sleeve is provided with a printing layer which wholly or partly envelops the outer surface. Printing plates may be adhered to the sleeve, for example, or a continuously seamless printing layer may be applied. Technologies for the application of continuously seamless printing layers are known to the skilled person. The sleeve provided with the printing layer is mounted onto a printing cylinder by means of the technique described at the outset, more particularly onto a metallic printing cylinder of a printing machine. Printing takes place with the printing cylinder equipped in this way.

1.-16. (canceled)

17. A method for producing glass fiber-reinforced sleeves for the printing industry by means of UV curing, comprising at least the following method steps:
(1) shaping of a UV-curable sleeve from glass fibers and a UV-curable resin,
(2) curing of the sleeve by UV irradiation,
where the glass fibers used are provided in an upstream method step with an adhesion-promoting coating, characterized in that the formulation used for the coating comprises electrically conductive nanoparticles.

18. The method as claimed in claim 17, characterized in that the electrically conductive nanoparticles comprise carbon nanotubes.

19. The method as claimed in claim 17, characterized in that the adhesion-promoting coating comprises organofunctional silanes.

20. The method as claimed in claim 17, characterized in that the weight fraction of the nanoparticles in the coating is 0.5 to 40 wt %, based on the sum of all of the constituents of the coating.

21. The method as claimed in claim 17, characterized in that the coating is used in an amount of 0.1 to 5 wt %, based on the glass fibers.

22. The method as claimed in claim 17, characterized in that method step (1) is performed by means of the filament winding process, where glass fibers impregnated with the UV-curable resin are applied under positional and tension guidance to a rotating cylindrical core.

23. The method as claimed in claim 17, characterized in that the fraction of the glass fibers in the sleeve is 55 to 80 wt %, based on the sum of all of the constituents of the sleeve.

24. The method as claimed in claim 17, characterized in that the sleeve is provided with a metallic component for the purpose of improving the conduction of electrical charge from the sleeve onto a metallic printing cylinder, the component joining the interior outer face of the sleeve to the interior of the sleeve wall.

25. The method as claimed in claim 24, characterized in that the metallic component is one selected from the group consisting of a perforated tab, a metal ring, and a contact pin.

26. The method as claimed in claim 17, characterized in that the UV-curable resin used is electrically nonconductive.

27. A glass fiber-reinforced sleeve for the printing industry, at least comprising glass fibers and a cured resin, characterized in that the glass fibers have an adhesion-promoting comprising electrically conductive nanoparticles.

28. The sleeve as claimed in claim 27, characterized in that the electrically conductive nanoparticles comprise carbon nanotubes.

29. The sleeve as claimed in claim 27, characterized in that the sleeve has a metallic component for the purpose of improving the conduction of electrical charge from the printing sleeve onto a metallic printing cylinder, the component being able to join the interior outer face of the sleeve to the interior of the sleeve wall.

30. The sleeve as claimed in claim 29, characterized in that the metallic component is one selected from the group consisting of a perforated tab, a metal ring, and a contact pin.

31. The sleeve as claimed in claim 27, obtainable by a method as claimed in claim 17.

32. The sleeve as claimed in claim 27, characterized in that further layers with different compositions are applied on the exterior surface of the sleeve.
